(19) United States
(12) Patent Application Publication
(10) Pub. No.: US 2026/0316884 A1
(43) Pub. Date: Oct. 15, 2026

(54) Method for Automatically Preventing a Bicycle from Rolling Backwards on a Slope, Control Device, Computer Program Product, Computer-Readable Medium, Bicycle

(71) Applicant: ZF Friedrichshafen AG, Friedrichshafen (DE)

(72) Inventors: Markus Wallner, Friedrichshafen (DE); Uwe Schraff, Markdorf (DE); Alexander Jungaberle, Schlier (DE)

(21) Appl. No.: 19/117,215

(22) PCT Filed: Sep. 29, 2022
(86) PCT No.: PCT/EP2022/077088

§ 371 Date: Mar. 31, 2025

(51) Int. Cl. B62M 6/50; B60L 15/20

(52) U.S. Cl. CPC B62M 6/50; B60L 15/2018; B60L 2200/12

(57) ABSTRACT

A method for automatically preventing a bicycle from rolling backwards on a slope, with the bicycle having a crank unit and an electrical propulsion system, and with the electrical propulsion system including at least one electric motor. The method includes determining a current inclination angle of the bicycle and a current output rotational speed of the bicycle. The method further includes comparing the current inclination angle with an inclination angle threshold value. Further, the method includes comparing the current output rotational speed with an output rotational speed threshold value. Additionally, the method includes increasing a motor torque of the at least one electric motor to a holding torque when the current inclination angle exceeds the inclination angle threshold value and the current output rotational speed exceeds the output rotational speed threshold value.

### CROSS-REFERENCE TO RELATED APPLICATION

The present application is a nationalization of PCT/EP2022/076615 filed in the European Patent Office on Sep. 26, 2022, the entirety of which is incorporated by reference for all purposes.

### FIELD OF THE INVENTION

The invention relates generally to a method for automatically preventing a bicycle from rolling backwards on a slope, to a control device, to a computer program product, to a computer-readable medium, and to a bicycle.

### BACKGROUND

Bicycles having an electrical (auxiliary) propulsion means, for example, e-bikes and pedelecs, are becoming increasingly popular. Sporty electric mountain bikes (eMTB) are also in use. When a bicycle rider is at a standstill on a slope, however, the bicycle can roll backwards if the brake is not actuated in a timely manner. This could pose a safety risk especially for inexperienced riders.

DE 10 2004 035 089 A1 describes a braking system with roll-back prevention for hybrid electric vehicles.

### SUMMARY OF THE INVENTION

The problem addressed by the invention is that of increasing the safety of a rider when stopped with a bicycle on a slope. This problem is solved by a method for automatically preventing a bicycle from rolling backwards on a slope, by a control device, by a computer program product, by a computer-readable medium, and by a bicycle.

In a method for automatically preventing a bicycle from rolling backwards on a slope, which bicycle has a crank unit and an electrical propulsion system with at least one electric motor, first a current inclination angle and a current output rotational speed of the bicycle are determined. The current inclination angle is compared with an inclination angle threshold value. The current output rotational speed is compared with an output rotational speed threshold value. If the current inclination angle exceeds the inclination angle threshold value and if the current output rotational speed exceeds the output rotational speed threshold value, a motor torque of the at least one electric motor is increased until a holding torque is reached.

The term “bicycle” refers, in this case, to all bicycles which have both an electrical (auxiliary) propulsion means as well as a drive operated by muscle power, wherein the bicycle can be propelled either purely by muscle power, purely electrically, or, in the hybrid mode, both by muscle power and electrically. In any case, the bicycle has a crank unit and an electrical propulsion system with at least one electric motor. The bicycle can also have a bicycle transmission, which can be, for example, a multi-speed transmission of planetary design, or a CVT transmission, or the like. The bicycle transmission can then be operatively connected to the electrical propulsion system. The bicycle transmission can also be operatively connected to the crank unit. The bicycle transmission can be a bottom bracket transmission or a hub gear. The bicycle can be, for example, an e-bike, a (high-speed) pedelec, an eMTB, a velomobile, a cargo bike, or another suitable micromobility vehicle.

The method can be activated, while the bicycle is being ridden, either by the bicycle rider when the rider wants assistance with holding the bicycle on a slope, or the method can be permanently active, so that the method is automatically carried out every time the bicycle is held on a slope. The method can also be deactivated by the rider when the rider no longer wants assistance.

In a first step of the method, the current inclination angle and the current output rotational speed of the bicycle are determined. The angle of inclination of the bicycle is a measure of the steepness of the slope of a route the bicycle is on. The angle of inclination is determined using sensors, for example, using an inclination angle sensor on the bicycle or using a sensor which is part of an external unit, for example, of a mobile terminal, such as a smartphone, a smartwatch, a fitness tracker, or the like. In the same step, the current output rotational speed is determined. The output rotational speed is a measure of whether and to what extent the bicycle is rolling backwards. The output rotational speed can be detected or tapped, for example, at a non-driven wheel of the bicycle. Alternatively, the output rotational speed can be tapped at a driven wheel of the bicycle. The output rotational speed is determined using sensors, for example, using a speed sensor on the bicycle. Alternatively, the output rotational speed can be determined using a computational model on the basis of other values which have been acquired using sensors.

The sensor data are transmitted to a control device on the bicycle. For this purpose, the control device is connected to the corresponding sensors for signal exchange. A connection which permits an exchange of signals is one in which data and signals can be exchanged between the connection partners. For this purpose, each connection partner has a corresponding interface. The data and signal transmission can be carried out either in a hard-wired manner or a wireless manner. The control device and the corresponding sensors therefore have interfaces which permit such a connection. When the sensor data of the external unit are to be used, data and signals are exchanged between the external unit and the control device of the bicycle, for example, via a radio link or by hard-wired communication.

In a subsequent second step, the current inclination angle is compared with the inclination angle threshold value. As a result, it is established whether the bicycle is located on a steep or moderate uphill gradient or on a downhill gradient. The inclination angle threshold value is stored in a memory device of the control device on the bicycle. The inclination angle threshold value is preferably preset by the manufacturer. For example, the inclination angle threshold value can be 2°, 5°, 10°, 15°, or even greater than 15°.

The term “threshold” or “threshold value” does not refer to a global limit value which cannot be physically exceeded or fallen below. Rather, this is a specific value, which a user has established. All value indicators are understood to include tolerances.

If the current inclination angle exceeds the inclination angle threshold value, the method is continued. If this is not the case, the method is terminated. The method is therefore used only on slopes that have a certain steepness, which is established on the basis of the inclination angle threshold value.

In a third step of the method, which follows the second step, the current output rotational speed is compared with the output rotational speed threshold value. As a result, it is established whether the bicycle is rolling backwards, i.e., is moving counter to the direction of travel. The output rotational speed threshold value is stored in the memory device of the control device on the bicycle. The output rotational speed threshold value is preferably preset by the manufacturer. If the current output rotational speed exceeds the output rotational speed threshold value, the method is continued. If this is not the case, the method is terminated.

Finally, if the current inclination angle exceeds the inclination angle threshold value and if the current output rotational speed exceeds the output rotational speed threshold value, the motor torque of the at least one electric motor is increased until a holding torque is reached. In other words, the motor power is automatically increased until the roll-back stops. Therefore, the bicycle rider who does not brake at all or brakes too late on the slope is assisted. When rolling backwards on steep terrain, this is a substantial positive safety feature for the bicycle rider.

According to one development, a current crank torque of the bicycle is additionally determined. This is preferably carried out simultaneously with the determination of the current inclination angle and the current output rotational speed. The crank torque is determined using sensors and transmitted to the control device of the bicycle. The crank torque is a measure of the muscle power applied by the rider, which the rider transmits to the crank unit via the pedals.

Thereafter, the current crank torque is compared with the holding torque in a fourth step of the method, which follows the third step. If the current crank torque falls below the holding torque, the motor torque of the at least one electric motor is increased until a holding torque is reached. Therefore, an additional check is carried out, wherein the result of the method remains the same. If the current crank torque exceeds or reaches the holding torque, the method is terminated. In this case, the rider applies enough muscle power to prevent rolling backwards with the bicycle.

According to one development, the motor torque is controlled in a closed loop according to the current output rotational speed and according to the current inclination angle. In other words, the current output rotational speed is permanently compared with the output rotational speed threshold value and the current inclination angle is permanently compared with the inclination angle threshold value, so that the method is permanently active.

A control device for a bicycle is connectable to an electrical propulsion system of the bicycle for signal exchange, and the control device carries out the method described above in the preceding description. The control device can be, for example, a domain ECU or an ECU.

When the control device is used in a bicycle, the control device is connected to the electrical propulsion system, specifically to the actuator system of the electrical propulsion system, for signal exchange, such that the control device can activate the actuator system. The control device can therefore request an increase in the motor power and thus an increase in the motor torque. In addition, the control device can sense or detect which torque is currently present.

When the control device is used in a bicycle, the control device is additionally connected to at least one sensor for signal exchange. The control device receives, for example, data regarding the current inclination angle or regarding the current output torque or, optionally, regarding the current crank torque, from the sensors. For example, the control device can be connected to a torque sensor, to an inclination angle sensor, and/or to a mobile terminal for signal exchange. When the control device is connected to the mobile terminal, the control device can receive data and signals from the mobile terminal that are acquired by the sensors in the mobile terminal. For example, the control device can use the inclination angle data, the speed data, the GPS data, or the like, of the mobile terminal.

A computer program product includes commands which, when the program is run by the above-described control device, prompt the control device to carry out the above-described method.

A computer-readable medium includes commands which, when run by the above-described control device, prompt the control device to carry out the above-described method. The computer-readable medium can be in the form, for example, of a data carrier or of a downloadable data stream.

The bicycle has an electrical propulsion system and the above-described control device, which electrical propulsion system is connected to the control device for signal exchange. The control device can therefore activate the actuator system of the electrical propulsion system, such that an increase of the motor torque can be requested. The bicycle can therefore carry out the above-described method for automatically preventing the bicycle from rolling backwards on a slope.

The bicycle additionally has the crank unit. The electrical propulsion system has at least one electric motor and one electrical energy store. The bicycle also has the bicycle transmission. Both the crank unit and the electrical propulsion system are connected to the bicycle transmission. In addition, the bicycle includes multiple sensors which are connected to the control device for signal exchange, for example, torque sensors, inclination angle sensors, and/or a mobile terminal.

### BRIEF DESCRIPTION OF THE DRAWINGS

Exemplary embodiments of the invention are shown in the figures. Wherein:

FIG. 1 shows a schematic view of a bicycle according to one exemplary embodiment,

FIG. 2 shows a schematic view of a method sequence for the riding situation shown in FIG. 1.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

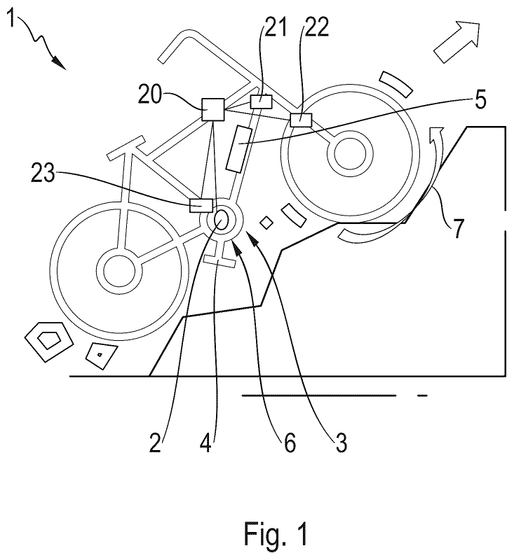

FIG. 1 shows a schematic view of a bicycle 1 according to one exemplary embodiment. The bicycle 1 is an e-bike or a pedelec or, in particular, an eMTB. The bicycle 1 has a crank unit 6, only the pedals 4 of which are shown for the sake of greater clarity. The bicycle 1 also has an electrical propulsion system 3, the electric motor of which can be located, for example, in the region of the bottom bracket. The electrical propulsion system 3 has an electrical energy store 5, which is connected to the electric motor. The electrical energy store 5 can supply the electric motor with electrical energy (operation as a motor) or can be supplied with electrical energy using the electric motor (operation as a generator).

The bicycle 1 also has a bicycle transmission 2. The bicycle transmission 2 is a bottom bracket transmission. The bicycle transmission 2 is operatively connected to the electrical propulsion system 3 and to the crank unit 6. The bicycle 1 can therefore be propelled either purely by muscle power or purely electrically or both by muscle power and electrically.

The bicycle 1 has a control device 20, which is connected to the electrical propulsion system 3, specifically to the actuator system of the electrical propulsion system 3, for signal exchange. The control device 20 can therefore activate the electrical propulsion system 3.

In addition, the bicycle 1 has multiple sensors which are connected to the control device 20 for signal exchange. The bicycle 1 has an inclination angle sensor 21, which is configured to determine the current inclination angle of the bicycle 1. This value is transmitted by the inclination angle sensor 21 to the control device 20, enabling a determination to be made on the basis of the inclination angle values as to whether the bicycle 1 is located on a steep slope 7.

The bicycle 1 has a speed sensor 22, which is configured to determine the current output rotational speed of the bicycle 1. The speed sensor 22 transmits this value to the control device 20. In this way, it can be established whether the bicycle 1 is rolling backwards, counter to the forward direction of travel indicated by the block arrow, due to the slope 7.

The bicycle 1 can have a crank torque sensor 23, which is configured to determine the current crank torque of the bicycle 1. The crank torque sensor 23 transmits this value to the control device 20.

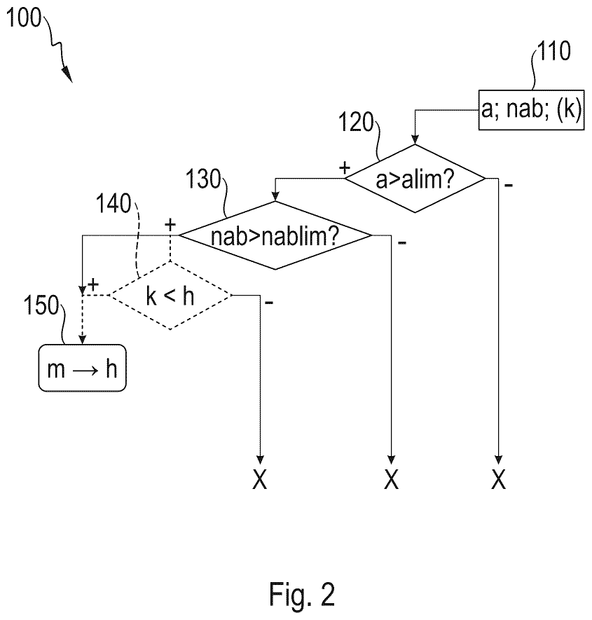

On the basis of the values which have been determined using sensors, the bicycle 1 can be automatically prevented from rolling backwards on the slope 7, as shown in the method flow chart in FIG. 2.

FIG. 2 shows a schematic view of a method sequence for the riding situation shown in FIG. 1. In the method flow chart of the method 100 for automatically preventing the bicycle from rolling backwards on the slope, an “X” indicates the termination of the method 100.

In a first step 110 of the method 100, a current inclination angle a and a current output rotational speed nab of the bicycle are determined. A current crank torque k of the bicycle is optionally additionally determined.

In a subsequent second step 120 of the method, the current inclination angle a is compared with an inclination angle threshold value alim. If the current inclination angle a is less than the inclination angle threshold value alim, the method 100 is terminated, since a slope is not present that is so steep that the method 100 would need to be carried out. If the current inclination angle a is greater than the inclination angle threshold value alim, the method 100 is continued.

In a subsequent third step 130 of the method, the current output rotational speed nab is compared with an output rotational speed threshold value nablim. If the current output rotational speed nab is less than the output rotational speed threshold value nablim, the method 100 is terminated, since a roll-back is not present that would make it necessary to carry out the method 100. If the current output rotational speed nab is greater than the output rotational speed threshold value nablim, the method 100 is continued.

The subsequently shown fourth step 140 is optional and is used to further increase the safety of the rider. In this optional fourth step 140 of the method 100, the current crank torque k is compared with the holding torque h, which holding torque is a value of the electric motor of the bicycle. If the current crank torque k is greater than the holding torque h, the method 100 is canceled, since the bicycle rider is applying the muscle power necessary to prevent the bicycle from rolling backwards. If the current crank torque k falls below the holding torque h, the method 100 is continued.

In a final step 150 of the method 100, the motor torque m of the at least one electric motor is increased until the holding torque h is reached. As a result, the bicycle is effectively prevented from rolling backwards on the slope and safety is increased. The final step 150 can follow the third step 130 when the optional fourth step 140 is omitted, otherwise the final step 150 follows the fourth step 140.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 bicycle
2 bicycle transmission
3 electrical propulsion system
4 pedal
5 energy store
6 crank unit
7 slope
20 control device
21 inclination angle sensor
22 speed sensor
23 crank torque sensor
100 method
110 first step
120 second step
130 third step
140 fourth step
150 final step
a current inclination angle
alim inclination angle threshold value
nab current output rotational speed
nablim output rotational speed threshold value
k current crank torque
h holding torque
m motor torque
X termination of the method

1-7. canceled

8. A method (100) for automatically preventing a bicycle (1) from rolling backwards on a slope (7), the bicycle (1) comprising a crank unit (6) and an electrical propulsion system (3), the electrical propulsion system (3) including at least one electric motor, the method comprising:
determining a current inclination angle (a) of the bicycle (1) and a current output rotational speed (nab) of the bicycle (1);
comparing the current inclination angle (a) with an inclination angle threshold value (alim);
comparing the current output rotational speed (nab) with an output rotational speed threshold value (nablim); and
increasing a motor torque (m) of the at least one electric motor to a holding torque (h) when the current inclination angle (a) exceeds the inclination angle threshold value (alim) and the current output rotational speed (nab) exceeds the output rotational speed threshold value (nablim).

9. The method (100) of claim 8, further comprising:
determining a current crank torque (k) of the bicycle (1);
comparing the current crank torque (k) with the holding torque (h); and
terminating the method (100) when the current crank torque (k) exceeds or reaches the holding torque (h),
wherein increasing the motor torque (m) of the at least one electric motor to the holding torque (h) further comprises increasing the motor torque (m) of the at least one electric motor to the holding torque (h) when the current crank torque (k) falls below the holding torque (h).

10. The method (100) of claim 8, wherein the motor torque (m) is permanently controlled in a closed loop according to the current output rotational speed (nab) and according to the current inclination angle (a).

11. A control device (20) for the bicycle (1), wherein the control device (20) is connectable to the electrical propulsion system (3) of the bicycle (1) for signal exchange, and wherein the control device (20) carries out the method (100) of claim 8.

12. A computer program product, comprising commands which, when the computer program product is run by the control device (20) of claim 11, prompt the control device (20) to carry out the method (100) of claim 8.

13. A computer-readable medium, comprising commands which, when the commands are run by the control device (20) of claim 11, prompt the control device (20) to carry out the method (100) of claim 8.

14. A bicycle (1), comprising the electrical propulsion system (3) and the control device (20) of claim 11.
